(19) United States
(12) Patent Application Publication
(10) Pub. No.: US 2018/0308375 A1
(43) Pub. Date: Oct. 25, 2018

(54) ACCESSIBLE CONTENT DEVELOPMENT

(71) Applicant: edX Inc., Cambridge, MA (US)

(72) Inventor: Piotr F Mitros, Cambridge, MA (US)

(21) Appl. No.: 15/962,274

(22) Filed: Apr. 25, 2018

Related U.S. Application Data
(60) Provisional application No. 62/489,544, filed on Apr. 25, 2017.

(51) Int. Cl. G09B 5/06; G06Q 50/20; G09B 21/00

(52) U.S. Cl. CPC G09B 5/067; G09B 21/00; G06Q 50/205

(57) ABSTRACT

A method for generating disability accessible educational content by a number of student users in a learning management system includes receiving user input from a student user of the learning management system indicating the student user's intention to generate disability accessible educational content associated with a corresponding conventional educational content in the learning management system, presenting the student user with a disability accessible educational content generation user interface, receiving user input from the student user at the disability accessible educational content generation user interface, the user input specifying disability accessible educational content associated with the corresponding conventional educational content, and storing the disability accessible educational content, in association with the conventional education content, in a data store associated with the learning management system.

### CROSS-REFERENCE TO RELATED APPLICATIONS

This application claims the benefit of Provisional Application Ser. No. 62/489,544, filed Apr. 25, 2017, the contents of which are hereby entirely incorporated herein by reference.

### BACKGROUND

This invention relates to development of accessible content for a learning management system.

Learning management systems administer, document, track, report, and deliver electronic educational courses or training programs to users. Some learning management systems include thousands of electronic educational courses which are administered to millions of users.

### SUMMARY

It is important and often required by law that reasonable accommodations be made for disabled users of online learning management systems. However, given the number of courses and the limited resources provided to course development teams, it is often difficult to accommodate even the most common disabilities for all courses included in the system. In some learning management systems with large numbers of users (i.e., millions of users), this problem is exacerbated due to the presence of the numerous and rare disabilities present in such a large population.

This difficulty in accommodating disabilities in the courses of learning management systems is a technological problem that has arisen from the new technology of online learning management systems. Aspects described herein provide a specific technological solution to this technological problem by integrating technological authoring tools into the online learning management system, enabling the many users of the system to author accessibility content. By leveraging the large number of users in the online learning management system, the amount of accessibility content that is developed for courses in the system is greatly increased. This increased amount of accessibility content is a clear improvement to the technological process of online learning management system administration.

The problem of accommodating disabilities in the courses of learning management systems specifically arises in the technological realm of online learning management system administration, where the distributed online nature of the system opens learning opportunities to significantly more students, especially those who have disabilities that would otherwise prevent them from physical attending the lectures and labs of traditional courses. Aspects described herein are necessarily rooted in computer technology to overcome the problem, arising in the technological realm of online learning management systems, of the difficulty in accommodating the many disabilities of users taking courses in the system. By integrating computer implemented authoring tools into the online learning management system the many users of the online learning management system are empowered to author accessibility content, resulting in an increase the amount of accessibility content in the system. Without being rooted in computer technology, it would be infeasible to provide the authoring tools to all of the many users of the system and it would be infeasible to collect and validate crowd-sourced accessibility content.

As is described in greater detail below, aspects described herein provide tools for authoring and presentation of accessibility content that are computer implemented and set forth formal steps that a human would not, or could not, possibly perform

The marketplace includes a number of online learning management systems, and the aspects described herein provide specific applications and improvements (e.g., to the authoring and presentation of accessibility content) over the online learning management systems currently in the marketplace.

Aspects described herein provide a mechanism for users (e.g., instructors, students, contributors) of a learning management system to author accessible content for courses of the learning management system. In doing so, the users of the learning management system develop a rich set of accessible versions of course content that provides users with a large variety of disabilities access to the courses.

Aspects described herein also manage the accessible content to ensure that it is maintained in an up-to-date and correct state. Aspects described herein also manage delivery of the accessible content according to content delivery rules and user profiles.

In a general aspect, a method for generating disability accessible educational content by a number of student users in a learning management system includes receiving user input from a student user of the learning management system indicating the student user's intention to generate disability accessible educational content associated with a corresponding conventional educational content in the learning management system, presenting the student user with a disability accessible educational content generation user interface, receiving user input from the student user at the disability accessible educational content generation user interface, the user input specifying disability accessible educational content associated with the corresponding conventional educational content, and storing the disability accessible educational content, in association with the conventional education content, in a data store associated with the learning management system.

Aspects may include one or more of the following features.

The disability accessible educational content may include one of phonetic text, semantic text, subtitles, video description audio, alternative video content, a text transcript, a version of the conventional education content with altered colors, and a version of the conventional educational content with an altered playback rate. Receiving user input from the student user at the disability accessible educational content generation user interface may include receiving an association of the disability accessible educational content with one or more disabilities for which the disability accessible educational content is suitable.

Storing the disability accessible educational content may include associating the disability accessible educational content with metadata including the one or more disabilities. The one or more disabilities may include one or more of attention deficit disorder, blindness, hearing loss, learning disabilities, detached retina, cataracts, color blindness, autism, asperger syndrome, down syndrome, dyslexia, memory loss, speech and language disorders, mental illness, mobility impairments, multiple sclerosis, and Parkinson's disease. The user input specifying disability accessible educational content associated with the corresponding conventional educational content may includes change to a pre-existing version of the disability accessible educational content.

The conventional educational content may include audio/video content. The disability accessible educational content generation user interface may include a first region for presentation of the conventional educational content to the student user and a second region for entering the user input specifying disability accessible educational content. The disability accessible educational content generation user interface may include one or more third regions for presentation of one or more other versions or types of disability accessible educational content associated with the conventional educational content to the student user. The method may include providing the disability accessible educational content to a second student user of the learning management system for review and revision.

In another general aspect, a method for presentation of disability accessible educational content to a user with a disability includes receiving user input from the user, the user input requesting presentation of conventional educational content, accessing a user profile associated with the user to determine the disability associated with the user, accessing an ordered list of disability accessible educational content types associated with the disability, accessing metadata associated with the conventional educational content to identify one or more versions of disability accessible educational content associated with the conventional educational content, identifying one or more candidate versions of disability accessible educational content for presentation to the user based on the disability associated with the user and the one or more versions of disability accessible educational content associated with the conventional educational content to, selecting a version of the disability accessible educational content from the one or more candidate versions of disability accessible educational content for presentation to the user based at least in part on the ordered list of disability accessible educational content types associated with the disability, and presenting the selected version of the disability accessible educational content to the user.

Aspects may have one or more of the following advantages.

Among other advantages, users of a learning management system deployed in large-scale settings (e.g. MOOCs) can contribute more content than a course development team can contribute alone. Furthermore, in settings with large number of learners, and especially with heterogenous bodies of learners, the content delivered by users can be delivered more quickly and at higher quality as compared to content delivered by the sometimes overworked and under-resourced course development teams. Crowdsourcing accessible content may result in content that is better tailored to various disabilities, since much of it may be contributed by users with such disabilities or directly for such users. In particular, it can allow for multiple versions of content for people with related but slightly different disabilities. Especially in use for shared resources across multiple residential classroom settings, such a system allows schools, who often have legal requirements to accommodate disabled students, to do so autonomously. Such contributions can then become useful in other classrooms with students with related disabilities, saving other schools cost of recreating such accommodations. Accessible content is also often helpful for non-disabled students as well. For example, audio versions of content authored for blind users is often useful in settings where visual content is not available (e.g. while commuting in a car or on a bicycle). It can provide alternative versions of explanations for when a student is confused by the standard version. It can provide text-only versions of AV content for student who either want to consume such content in an environment where noise is not appropriate, or who want to skim. It can be used to extract additional metadata useful for indexing course content for search and otherwise.

Other features and advantages of the invention are apparent from the following description, and from the claims.

### DESCRIPTION OF DRAWINGS

FIG. 1 is a learning management system.

FIG. 2 is a learning interface of the learning management system of FIG. 1.

FIG. 3 is an accessible content authoring interface of the learning management system of FIG. 1.

FIG. 4 is an accessible content authoring user interface.

FIG. 5 is an accessible content editing user interface.

FIG. 6 is an accessible content lineage diagram.

FIG. 7 is an accessible content type tagging user interface.

FIG. 8 is a flowchart of an indirection method.

FIG. 9 is a course content listing user interface.

FIG. 10 is a content selection user interface.

### DESCRIPTION

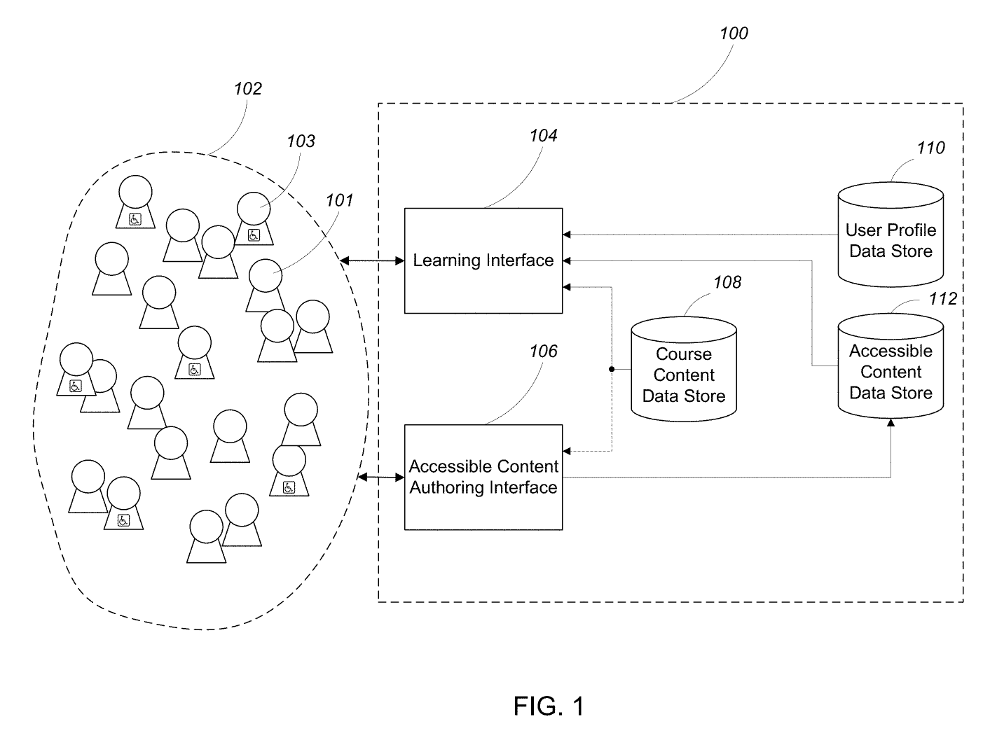

Referring to FIG. 1, a learning management system 100 administers, documents, tracks, reports, and delivers electronic educational courses or training programs to a population of users 102. As is generally the case with human populations, the population of users 102 includes a mixture of able bodied users 101 and disabled users 103. Very generally, the learning management system 100 facilitates authoring of accessible content for use by the disabled users 103 (or the able-bodied users 101 if they so desire) by users in the population of users 102. That is, accessible content is crowd sourced from the population of users 102.

The learning management system 100 includes a learning interface 104, an accessible content authoring interface 106, a course content data store 108, a user profile data store 110, and an accessible content data store 112.

The learning interface 104 presents course content (e.g., a lecture) and/or accessible content (e.g., a transcription of a lecture) to users of the population of users 102 and receives user input (e.g., questions or answers) from the users of the population of users 102. The learning interface 104 accesses the user profile data store 110 to retrieve a user profile for a particular user from the population of users. Based on the user profile for the particular user, the learning interface 104 determines whether content presented to the particular user for a particular course includes course content from the course content data store 108, accessible content from the accessible content data store 112, or a combination of the two.

The accessible content authoring interface 106 provides an interface for the users of the population of users 102 to author accessible content for storage in the accessible content data store 112 and use by the learning interface 104.

In some examples, the accessible content authoring interface 106 receives course content from the course content data store 108, modifies the received course content to include accessibility features, and then stores the modified course content in the accessible content data store 108 as accessible content. In some examples, the accessible content authoring interface 106 receives course content from the course content data store 108 and an author creates original accessible content based on the course content (e.g., by viewing the course content), which is then stored in the accessible content data store 108 as accessible content. In some examples, the accessible content authoring interface 106 is used to create original accessible content without accessing the any course content from the course content data store 108.

In some examples, some or all instances of accessible content stored in the accessible content data store 112 are associated (e.g., by metadata) with an instance of course content in the course content data store 108 and are associated with one or more disabilities.

As is noted above, the population of users 102 includes at least some users with disabilities. The disabilities represented in the population of users 102 range from the relatively common (e.g., blindness or deafness) to the relatively rare (e.g., retinal detachment). Furthermore, the individual disabilities may be associated with varying degrees of disability (e.g., partial blindness) in the population of users 102. As is described in greater detail below, the content authoring interface 106 provides a rich set of tools for authoring content to accommodate any number of disabilities, including common and well known disabilities and disabilities that were not anticipated at the time that the accessible content authoring interface 106 was developed.

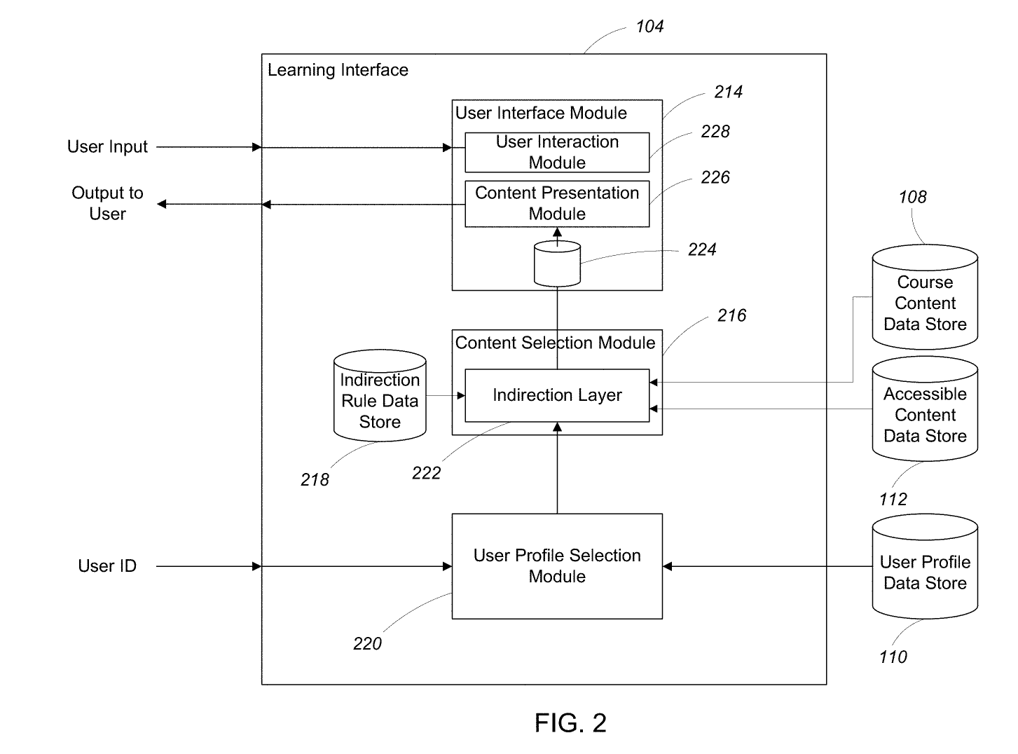

Referring to FIG. 2, the learning interface includes a user interface module 214, a content selection module 216, an indirection rules data store 218, and a user profile selection module 220.

When a user logs into the learning management system 100 to access a particular course content, the user's user ID provided to the learning interface 104 is received by the user profile selection module 220. The user profile selection module 220 also receives a set of user profiles from the user profile data store 110 and selects a user profile associated with the user ID from the set of user profiles. In general, the user's user profile includes characteristics of the user including any disabilities that the user may have, a degree of those disabilities, and the user's accessibility preferences. For example, the user's user profile may indicate that the user is partially blind and prefers to view course content as a video while listening to an accompanying video description track.

The selected user profile is provided to the content selection module 216 along with a set of indirection rules from the indirection rules data store 218, the course content from the course content data store 108, and accessible content from the accessible content data store 112. In general, the indirection rules specify general rules about which types of accessible content should be presented to a given disability. For example, an indirection rule may specify that video description accessible content should be presented to a user who is blind. Another exemplary indirection rule may specify that textual transcript accessible content for a course should be presented to a user who is deaf.

An indirection layer 222 included in the content selection module 216 selects course content and/or accessible content for presentation to the user based on the user profile, the set of indirection rules, and metadata associated with the accessible content. For example, if the user profile indicates that the user is blind, then the indirection layer 222 selects video description accessible content with metadata indicating that the content is suitable for blind users for presentation to the user. Of course, if the user's user profile indicates that the user has alternative accessible content preferences, then the indirection layer takes those preferences into account in its selection of accessible content to the user. For example, if the user profile indicates that the user is blind but the user indicates that they prefer to receive video content accompanied by video description accessible content (e.g., if the user has limited sight), then the indirection layer 222 selects normal video content and video description accessible content for presentation to the user. In some examples, the selection of accessible content for presentation to the user is performed automatically. In other examples, the user is presented with a list of accessible content to choose from.

In some examples, the output of the indirection layer 222 is provided directly to the user interface module 214. In some examples, the output of the indirection layer 222 is processed by the content selection module 216 prior to being provided to the user interface module 214. For example, transcripts or subtitles may be overlaid on video content prior to providing the video content to the user interface module 214.

The content 224 output by the content selection module, including the appropriate accessible content, is provided to a content presentation module 226 included in the user interface module 214, which presents the content 224 to the user. The user can interact with the user interface module based on the presented content via a user interaction module 228.

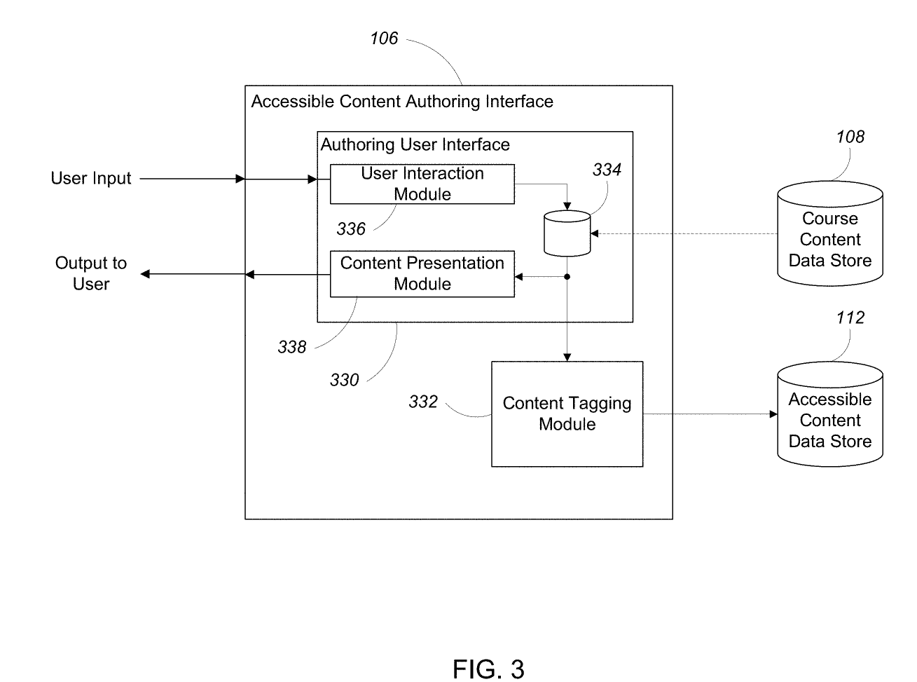

Referring to FIG. 3, the accessible content authoring interface 106 includes an authoring user interface 330 and a content tagging module 332. When a user authors accessible content 334 for a course, they may optionally request course content for the course from the course content data store 108 via a user interaction module 336 of the authoring user interface 330. The user may then view (or listen to) the course content, possibly simultaneously with the accessible content 334, using a content presentation module 338 of the authoring user interface 330. Alternatively, the user may author the accessible content 334 without accessing any course content from the course content data store 108.

The user author's accessible content by entering the accessible content into the authoring interface 106 through a user interaction module 336. In some examples, the content is entered as audio/video content. In some examples, the content is entered as semantic subtitles, expressing the same content of a video, but designed for usability be people who cannot hear the audio at al. (e.g., “Let x=y+5”). In some examples, the content is entered as linguistic subtitles, designed to help people hard of hearing (e.g., “If we let x be equal to the sum of y and 5”). In some examples the content is entered as audio and/or text descriptions of images, video, and other visual content. In some examples, the content is entered as text descriptions of sounds in audio and audio/video content. In some examples, the content is entered as content designed for alternative devices, such as Braille readers. In some examples, the content is entered as interactive content, such as problems, questions, and interactives. In some examples, the content is entered as full text+image versions of video content (e.g. a PDF, HTML, or ePub text). In some examples, the content is entered as modifications to existing content (e.g. additions of HTML ARIA tags to course staff authored content). In some examples, the content is entered as variants of content designed for ADHD, Autism, and other mental disabilities, where sensory organs have full function, but design of content is different. In some examples, the content is entered as versions of content targeting very specific disabilities. For example, users with a detached retina may not be able to saccade their eyes. In such a case, videos may be produced where the subject is always in the center

In some examples, rather than entering original accessible content into the authoring interface 106, users modify existing content to be more accessible to users with certain disabilities by, for example, altering color palettes or adjusting playback rates of audio or video content.

In some examples, the accessible content is iteratively refined by repeatedly presenting the accessible content 334 to the user and accepting refinements to the accessible content 334 from the user via the user interaction module 336.

Once the user is satisfied with the accessible content 334, the accessible content 334 is provided to the content tagging module 332. The content tagging module 332 associates metadata with the accessible content 334 such that the accessible content can be readily accessed (e.g., by the content selection module 216 of FIG. 2) and maintained in an updated state. For example, the content tagging module 332 may associate the accessible content with a particular course content, a specific version of a particular course content, an accessible content type and/or one or more disabilities.

The tagged accessible content is output from the content tagging module 332 and stored in the accessible content data store 112 for later use.

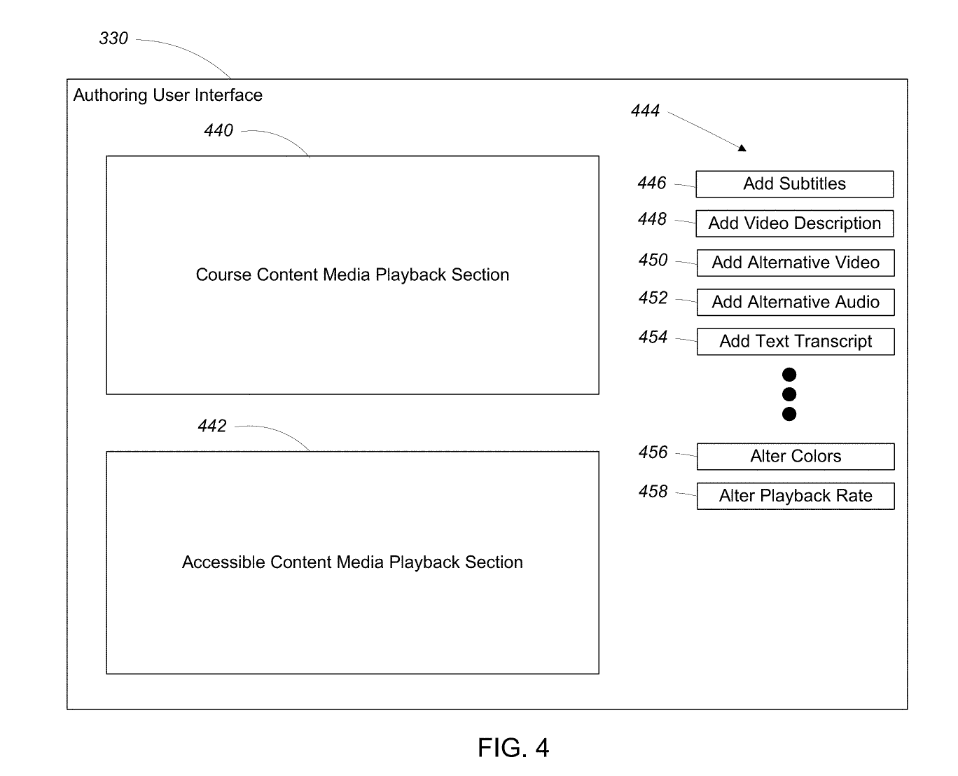

Referring to FIG. 4, one example of the authoring user interface 330 includes a course content media playback section 440, an accessible content media playback section 442, and a number of controls 444 for adding accessible content. The course content media playback section 440 is used to view or listen to course content. The accessible content media playback section 442 is used to view or listen to accessible content (sometimes overlaid on or accompanied by the course content).

The controls 444 are used by a user to select accessibility features to add to the accessible content. In some examples, the controls 444 include but are not limited to an “Add Subtitles” control 446, an “Add Video Description” control 448, an “Add Alternative Video” control 450, an “Add Alternative Audio” control 452, an “Add Text Transcript” control 454, an “Alter Video Color” control 456, and an “Alter Playback Rate” control 458.

When a user activates the “Add Subtitles” control 446, the authoring user interface 330 accepts subtitles for addition to the accessible content (e.g., via time-stamped text file or a manual input dialog). Upon adding subtitles, the user can view the subtitles overlaid on the course content video in the accessible content media playback section 442.

When a user activates the “Add Video Description” control 448, the authoring user interface 330 accepts a video description (i.e., audio-narrated descriptions of the course content's key visual elements) for the course content (e.g., via an audio file or an audio recording interface). Upon adding the video description, the user can listen to the video description via the accessible content media playback section 442, possibly while video course content is also displayed in the accessible content media playback section 442.

When a user activates the “Add Alternative Video(s)” control 450, the authoring user interface 330 accepts an alternative video(s) (e.g., video of the course being taught using a different teaching method) for the course content (e.g., via a video file or a video recording interface). Upon adding the alternative video(s), the user can view the video(s) in the accessible content media playback section 442.

When a user activates the “Add Alternative Audio” control 452, the authoring user interface 330 accepts alternative audio (e.g., audio of the course being taught using a different teaching method) for the course content (e.g., via one or more audio files or an audio recording interface). Upon adding alternative audio, the user can listen to the alternative audio in the accessible content media playback section 442.

When a user activates the “Add Text Transcript” control 454, the authoring user interface 330 accepts a text transcript (e.g., a textual representation of the course content) for the course content (e.g., via a text file or a manual input dialog). Upon adding a text transcript, the user can read the text transcript in the accessible content media playback section 442.

When a user activates the “Alter Video Colors” control 456, the authoring user interface 330 accepts color alteration commands for altering the colors used in the course content (e.g., to accommodate those with color blindness). Upon altering the video colors, the user can view the altered video content in the accessible content media playback section 442.

When a user activates the “Alter Playback Rate” control 458, the authoring user interface 330 accepts playback rate commands for altering the playback rate of video or audio in the course content (e.g., to accommodate those with slower or quicker uptake rates). Upon altering the playback rate, the user can view the playback rate altered content in the accessible content media playback section 442.

While the authoring user interface 330 is generally described as being used to create accessible content, it is noted that the same authoring user interface 330 is also configured to load existing accessible content for the purpose of allowing users to edit, improve, and review the accessible content.

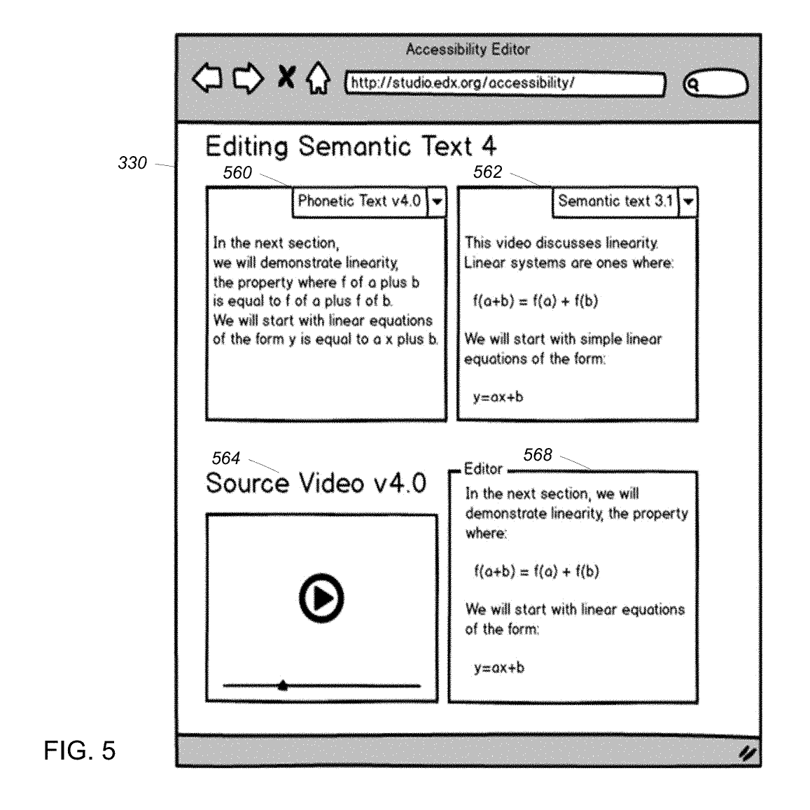

Referring to FIG. 5, an accessible content editing user interface 330 is configured for editing semantic text associated with a source video. The content editing user interface 330 includes a first display pane 560 for displaying a version of phonetic text associated with the source video, a second display pane 562 for displaying a version (e.g., the current version) of the semantic text associated with the source video, a third display pane 564 for displaying a version of the source video, and a fourth display pane 568 for editing the semantic text associated with the source video.

In operation, a user may wish to simultaneously multiple versions of the content. For example, a user creating semantic text for a video with phonetic text may want to use the phonetic text as a starting point, with the source video as the ground truth. If the video is updated, they may wish to see prior versions of the semantic text, most recent version of the phonetic text, and the video, at the same time. For example, if there is a 25 minute video, with phonetic and semantic transcriptions, and a 5 minute segment is added, one user might combine the previous version of the phonetic transcription to re-add the missing 5 minutes. Another user might wish to update the semantic transcription. Such a user would start with the previous semantic transcription, paste in the five minutes of phonetic transcription current to the video, and convert that five minutes from phonetic to semantic description. At the end, the user may want to compare to video to make sure the final transcription is correct.

The system can facilitate the steps in the previous section by also allowing a user to see and focus on the changes between versions. For example, if a video 1.0 and 2.0 has a phonetic transcription, and only 1.0 has a semantic description, a difference of the 1.0 and 2.0 versions of the video and the phonetic description can guide the user to where there is work to be done.

The first pane 560 and the second pane 562 include drop-down menus for selecting different types of the content. In this case, the display defaulted to displaying the most recent video, the most recent version of the phonetic text, and the most recent versions of the semantic text, since those are most helpful for creating a new version of the semantic text. The user may want to select e.g. slides or other variants of the content, as helpful for authoring. This control may also contain search functionality, or be organized as two drop-downs (one for type of content, and a child one for the version). Viewing older versions of the content is a less common use case, but is occasionally helpful, for example, if there are reversions in the video (e.g. version 4 re-incorporates elements from version 2 removed in version 3).

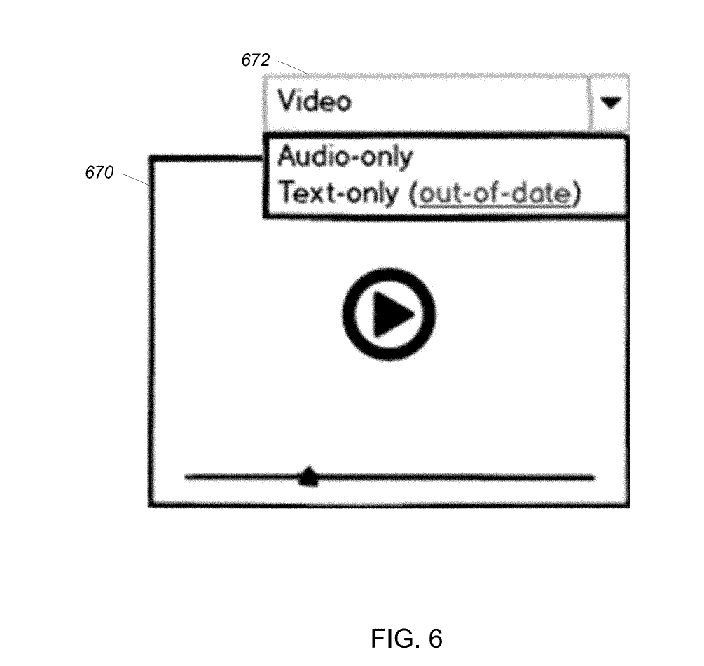

FIG. 6 shows a walk-through of an example content authoring flow. The instructor creates video 1.0, and then video 1.1. A volunteer converts the video to a phonetic transcript, then a semantic transcript, and another user converts it to a text document (all version 1.1). The instructor releases version 1.2 with minor changes. The transcripts are not updated (either because the changes are trivial, or due to lack of volunteers). The instructor creates a major revision, 2.0, re-recording most of the video. A user converts the old 1.1 semantic transcript into a new semantic transcript corresponding to the 2.0 video. The instructor releases a minor revision, 2.1, video. A user converts the 2.0 semantic transcript into a 2.1 phonetic transcript. The semantic transcript is close enough to the source video that it is not updated. The instructor re-records a 3.0 video from scratch. A student redoes the text document. Neither transcript are updated, and disabled students are left with the v2.1 video. The instructor releases a 4.0 video. A student creates a phonetic transcript, borrowing a small number of elements from the 3.0 transcript. Another student converts that to a semantic 4.0 transcript. Another student integrates the old text document and the current semantic transcript into a new text document. The instructor records a 5.0 video, and the process continues.

### Indirection Rules

In some examples, the indirection rules of FIG. 2 are simply specified by system administrators. In other examples, the indirection rules are collectively formed by the population of users. For example, a user might add a new disability to the system (“detached retina”). At that point, they may specify a set of preferences based on what content is available. For example, a user may wish to specify that a user with a detached retina will see audio-only content if it is current, available, and of high quality. Otherwise, they will see high quality video. Otherwise, they will see low-quality audio. Otherwise, they will see default content for a user with no disabilities.

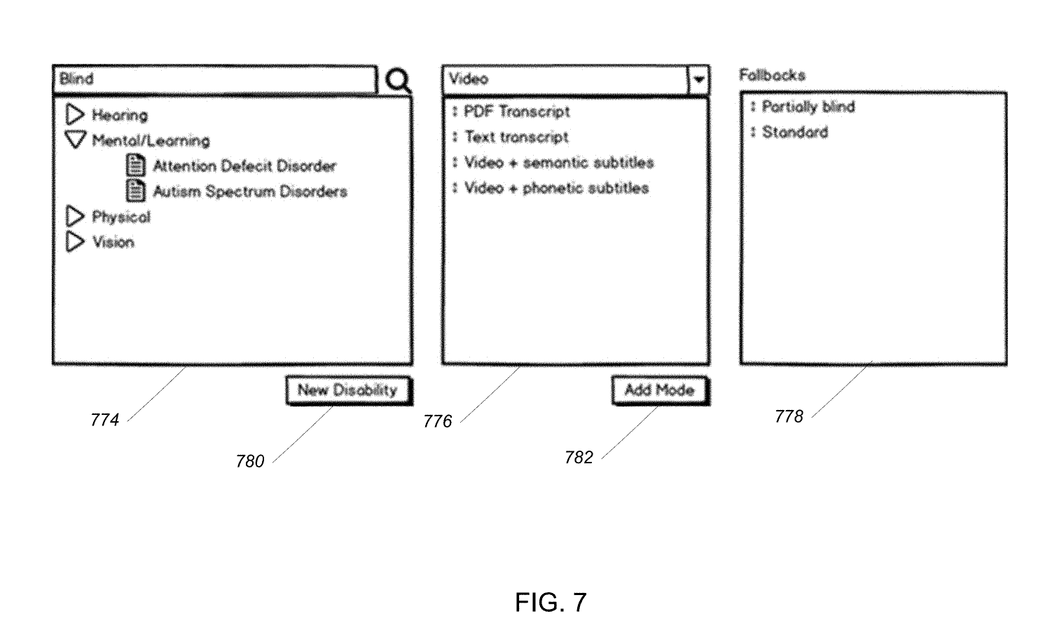

Referring to FIG. 7, an interface 773 for this type of tagging is shown. The interface 773 includes a first pane 774 for finding a specific disability. The first pane 774 includes a search feature at the top, and a hierarchical navigation below that. The user can also add a new disability using a ‘New Disability’ button 780. A second pane 776 displays, for the selected disability (currently not shown, since the user is searching for “blind”), an indirection sequence for accessible content. For example, in the figure it is specified that the user would be first directed to a PDF version of the accessible content, then a text version of the accessible content, then a video with semantic subtitles of the accessible content, then a video with phonetic subtitle of the accessible content. An “Add Mode” button associated with the second pane 774 lets a user add modes such as video, audio, video and semantic transcript, video and phonetic transcript, a sequence of problems, a text document, a braille optimized mode, and so on. In general, on a subset of the modes are relevant to a given disability. For example, a pure audio version of content would not be presented to a deaf person. The “Add Mode” button therefore can be used to add another mode that is relevant to the selected disability. A third pane 778 of the interface 773 shows fallback options for situations where none of the version of accessible content in the second pane 776 are available. For example, if none of the versions of accessible content specified for a blind user are available, then the user would be shown the best content for a partially blind user. If none of those are available, the user is shown standard content.

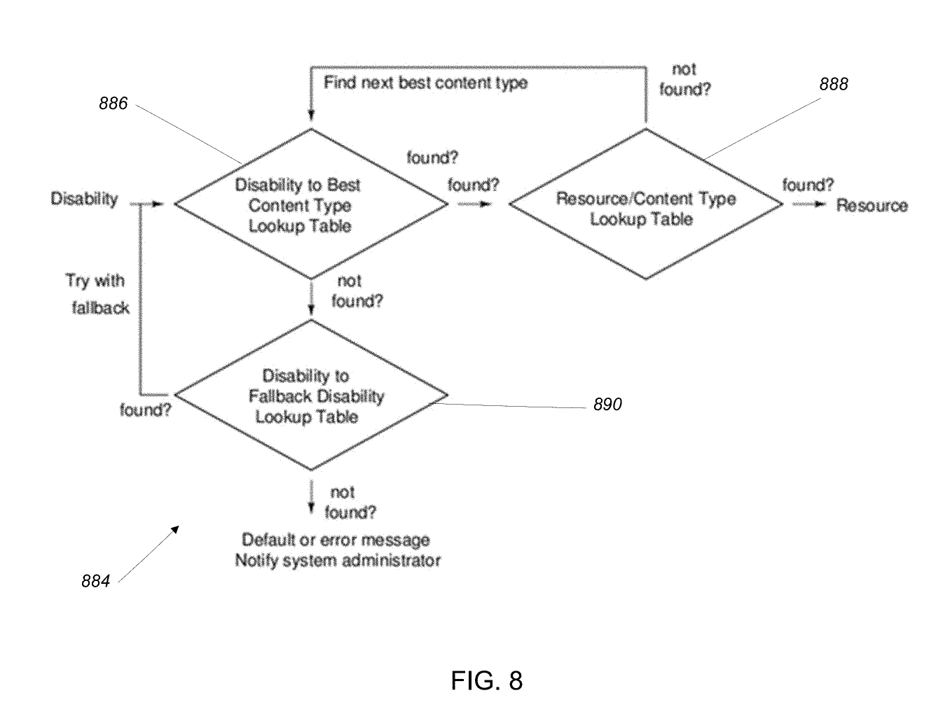

Referring to FIG. 8, a flowchart 884 of an indirection method operates according to the rules configured in the interface 773 of FIG. 7. In particular, when a user with a disability requests a resource, their disability is provided as input to the flowchart 884. The disability is then provided to a first step 886 which determines if a preferred content type for a resource to display to a user with that disability exists. If a preferred content for the disability is exists, the method proceeds to a second step 888 which checks whether the preferred content type exists for that resource. If the second step 888 determines that the preferred content type does exist for that resource, the method completes and the preferred content type is presented to the user. If the second step 888 determines that the preferred content type does not exist for that resource, then the method loops back to the first step 886 and determines if a second preferred content for the disability exists. The first step 886 and the second step 888 execute as described above until either a preferred content type for the resource is found and presented to the user or the first step determines that no preferred content types exist or can be found.

If no preferred content types exist or no preferred content types can be found in the first step 886, the method proceeds to a third step 889 where a fallback disability is identified (e.g., for a partially blind user, a fallback disability might be complete blindness). The method then repeatedly performs the first step 886 and the second step 888 (as described above) until either a preferred content type for the fallback disability is found and presented to the user or it is determined that no preferred content type is available for the fallback disability. If no preferred content type is available for the user's disability or any of the user's fallback disabilities, a default behavior is performed. For example, the default behavior may include informing the user (and apologizing to the user that) no resources exist for their disability, displaying a non-accessible resource, and relying on the user's tools for making it accessible, transforming the resources server-side (e.g. automated speech recognition to generate a video transcript), and/or informing the ADA administrator at the organization of the issue the user encountered.

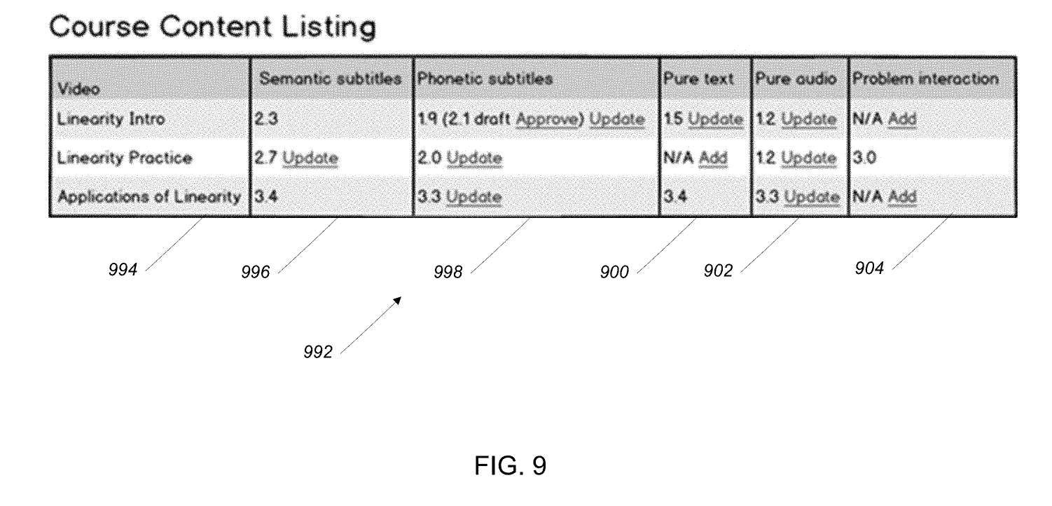

Referring to FIG. 9, if a user wishes to override content (e.g., default content, or content that they believe can be improved), they can view a course content listing 992 which allows users to view resources along with their associated accessible content. Users can use the course content listing 992 to update, add, and/or approve accessible content for resources. The course content listing includes a video pane 994, a semantic subtitles pane 996, a phonetic subtitles pane 998, a pure text pane 900, a pure audio pane 902, and a problem interaction pane 904. The video pane 994 shows the user the resources (e.g., videos) associated with a given course.

The semantic subtitles pane 996 shows the user a current version of semantic subtitles associated with each resource of the course. For at least some versions of semantic subtitles in the semantic subtitles pane 996, the user is presented with hyperlinks that allow the user to add, update, or approve semantic subtitles for the resource. Add means creating new ones. Update means taking an older version and updating to the current video. Approve means reviewing a different user's contribution and approving (or rejecting).

The phonetic subtitles pane 998 shows the user a current version of phonetic subtitles associated with each resource of the course. For at least some versions of phonetic subtitles in the phonetics subtitles pane 998, the user is presented with hyperlinks that allow the user to add, update, or approve semantic subtitles for the resource.

The pure text pane 900 shows the user a current version of pure text version of each resource of the course. For at least some versions of the pure text in the pure text pane 900, the user is presented with hyperlinks that allow the user to add, update, or approve pure text for the resource.

The pure audio pane 902 shows the user a current version of pure audio version of each resource of the course. For at least some versions of the pure text in the pure audio pane 902, the user is presented with hyperlinks that allow the user to add, update, or approve pure audio for the resource.

The problem interaction pane 904 shows the user a current version of the problem interaction version of each resource of the course. Here, a user learns a concept by answering a series of problems or questions. For at least some versions of the problem interaction in the problem interaction pane 904, the user is presented with hyperlinks that allow the user to add, update, or approve problem interaction for the resource.

In operation, a user interacts with the course content listing 992 by finding resources which need transcription, conversion to pure audio, or otherwise creation, approval, or updates of accessible version, and which the user is capable of doing so with, and the user may do so. The system may filter by operations the user has indicated the user prefers (e.g. a user may choose to only take on video transcription tasks) or by the user's level of permissions.

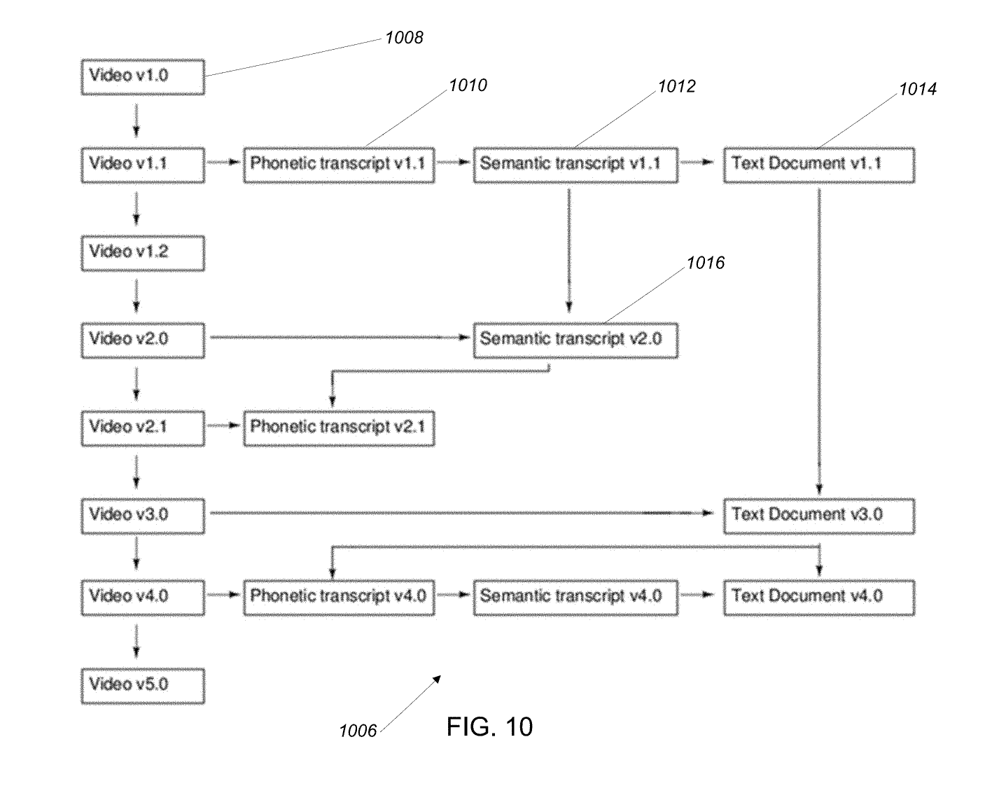

Referring to FIG. 10, a content selector user interface 669 includes a presentation pane 670 and a drop down menu 672. In general, a user uses the content selector user interface 669 to switch between versions of the content. For example, a user watching a video might switch to an audio-only version when riding a bicycle, or to a pure text version in a loud train. A user with a disability may switch between versions based both on which is most recent, the type of that user's disability, and the current context.

### Alternatives

A number of exemplary disabilities are described above for the purpose of explaining how the learning management system facilitates crowd sourced authoring of accessible content. However, it is noted that the learning management system is configured to be sufficiently flexible to allow users of the system to author accessible content for virtually any disability. Some examples of other disabilities for which accessible content can be authored using the approaches described above include but are not limited to attention deficit disorder, blindness, deafness or hearing loss, learning disabilities or intellectual disabilities, detached retina, cataracts, color blindness or other eye-related disabilities, autism, asperger syndrome, down syndrome, dyslexia, memory loss, speech and language disorders, mental illness, mobility impairments such as muscular dystrophy, multiple sclerosis, and Parkinson's disease.

In some examples, a user's accessibility preferences are automatically discovered based on the user's use history of the learning management system. In some examples, the user can manually configure their accessibility preferences.

In some examples, the authoring user interface can be used to edit pre-existing accessible content.

In some examples, accessible content is authored as an augmentation to existing course content. In some examples, accessible content is authored as original content that is meant to convey the same or similar concepts as the existing course content. In some examples, accessible content is a version of the existing course content that is divided into smaller sections.

In some examples, able-bodied users are also provided access to accessible content. For example, an able-bodied user may choose to listen to an audio-only version of a video course content while the commute into work.

It is to be understood that the foregoing description is intended to illustrate and not to limit the scope of the invention, which is defined by the scope of the appended claims. Other embodiments are within the scope of the following claims.

What is claimed is:

1. A method for generating disability accessible educational content by a plurality of student users in a learning management system, the method comprising:
receiving user input from a student user of the learning management system indicating the student user's intention to generate disability accessible educational content associated with a corresponding conventional educational content in the learning management system;
presenting the student user with a disability accessible educational content generation user interface;
receiving user input from the student user at the disability accessible educational content generation user interface, the user input specifying disability accessible educational content associated with the corresponding conventional educational content; and
storing the disability accessible educational content, in association with the conventional education content, in a data store associated with the learning management system.

2. The method of claim 1 wherein the disability accessible educational content comprises one of phonetic text, semantic text, subtitles, video description audio, alternative video content, a text transcript, a version of the conventional education content with altered colors, and a version of the conventional educational content with an altered playback rate.

3. The method of claim 1 wherein receiving user input from the student user at the disability accessible educational content generation user interface includes receiving an association of the disability accessible educational content with one or more disabilities for which the disability accessible educational content is suitable.

4. The method of claim 3 wherein storing the disability accessible educational content includes associating the disability accessible educational content with metadata including the one or more disabilities.

5. The method of claim 3 wherein the one or more disabilities include one or more of attention deficit disorder, blindness, hearing loss, learning disabilities, detached retina, cataracts, color blindness, autism, asperger syndrome, down syndrome, dyslexia, memory loss, speech and language disorders, mental illness, mobility impairments, multiple sclerosis, and Parkinson's disease.

6. The method of claim 1 wherein the user input specifying disability accessible educational content associated with the corresponding conventional educational content includes changes to a pre-existing version of the disability accessible educational content.

7. The method of claim 1 wherein the conventional educational content includes audio/video content.

8. The method of claim 1 wherein the disability accessible educational content generation user interface includes a first region for presentation of the conventional educational content to the student user and a second region for entering the user input specifying disability accessible educational content.

9. The method of claim 8 wherein the disability accessible educational content generation user interface includes one or more third regions for presentation of one or more other versions or types of disability accessible educational content associated with the conventional educational content to the student user.

10. The method of claim 1 further comprising providing the disability accessible educational content to a second student user of the learning management system for review and revision.

11. A method for presentation of disability accessible educational content to a user with a disability, the method comprising:
receiving user input from the user, the user input requesting presentation of conventional educational content;
accessing a user profile associated with the user to determine the disability associated with the user;
accessing an ordered list of disability accessible educational content types associated with the disability;
accessing metadata associated with the conventional educational content to identify one or more versions of disability accessible educational content associated with the conventional educational content;
identifying one or more candidate versions of disability accessible educational content for presentation to the user based on the disability associated with the user and the one or more versions of disability accessible educational content associated with the conventional educational content to;
selecting a version of the disability accessible educational content from the one or more candidate versions of disability accessible educational content for presentation to the user based at least in part on the ordered list of disability accessible educational content types associated with the disability; and
presenting the selected version of the disability accessible educational content to the user.
